(19) United States
(12) Patent Application Publication
(10) Pub. No.: US 2009/0081362 A1
(43) Pub. Date: Mar. 26, 2009

(54) Apparatus and method for distributing particulate material onto a moving web

(75) Inventors: Walter S. Egyed, Warner Robins, GA (US); Lonnie Smith, Haddock, GA (US); Brian Dyer, Gray, GA (US)

Correspondence Address: AMSTER, ROTHSTEIN & EBENSTEIN LLP, 90 PARK AVENUE, NEW YORK, NY, 10016, US

(73) Assignee: Tyco Healthcare Retail Services AG, Neuhausen am Rheinfall (CH)

(21) Appl. No.: 11/904,228

(22) Filed: Sep. 26, 2007

(51) Int. Cl. B05D 1/12; B05D 7/00

(52) U.S. Cl. 427/180; 118/308

(57) ABSTRACT

A particulate delivery apparatus for distributing particulate material onto a target area of a web moving in a first direction can generally have a hopper for receiving a supply of particulate material and a one or more tubular members having an inlet end communicating with the hopper and an outlet end for discharging the particulate material from the hopper onto the target area. The tubular member(s) can extend downwardly from the bottom of the hopper at an angle toward the web, such that the particulate material is discharged onto the web, and in the same direction the web is moving. A plurality of separate flow paths can be provided in the tubular member(s) such that the particulate material is discharged as a plurality of separate streams. The width of the outlet end(s) can approximate the width of, and be oriented along the same axis as, the width of the target area.

### BACKGROUND

The apparatus and method for distributing particulate material onto a moving web described herein relate generally making disposable absorbent articles, and more particularly to a apparatus and method for distributing particulate material, for example, super absorbent particles (SAP), onto an absorbent core which is carried on a moving web during manufacture of the disposable absorbent articles.

Absorbent articles or garments such as, for example, disposable diapers, training pants, adult incontinent pads, sanitary napkins, pantiliners, incontinent garments, etc., are generally worn, in cooperation with garments and disposed against a body surface by infants or adult incontinent individuals. The absorbent article is employed to collect and absorb body fluid discharge, such as, for example, blood, menses, urine, aqueous body fluids, mucus and cellular debris. For example, the absorbent article may be disposed between the legs of an individual adjacent a crotch area, and positioned in engagement with a body surface of the crotch area to collect fluid discharge.

As is known, absorbent articles typically include a fluid permeable cover stock for engaging the body surface, a fluid impermeable backsheet and an absorbent core supported therebetween. The backsheet serves as a moisture barrier to prevent fluid leakage to the garment. The absorbent core usually includes a liquid retention material that faces the body surface. The absorbent core can include, for example, loosely formed cellulosic fibers, such as, for example, wood pulp, fluff pulp, etc., for acquiring and storing body discharge.

Much effort has been expended to find cost-effective materials for absorbent cores that display good liquid absorbency and retention. Particles of super absorbent materials (SAP) in the form of granules, beads, fibers, bits of film, globules, etc., have been favored for such purposes. Such SAP materials generally are polymeric gelling materials that are capable of absorbing and retaining even under moderate pressure large quantities of fluids, such as water and body wastes, relative to their weight. The SAP particles have commonly been distributed within a fibrous web of fluffed pulp material, which may comprise natural or synthetic fibers. Such absorbent structures are commonly referred to as fluff pulp/SAP cores.

Super absorbent material generally is a water-insoluble but water-swellable polymeric substance capable of absorbing water in an amount that is greater than the weight of the substance in its dry form. In one type of super absorbent material, the particles may be described chemically as having a back bone of natural or synthetic polymers with hydrophilic groups or polymers containing hydrophilic groups being chemically bonded to the back bone or an intimate admixture therewith. Included in this class of materials are modified polymers such as sodium neutralized cross-linked polyacrylates and polysaccharides including, for example, cellulose and starch and regenerated cellulose that are modified to be carboxylated, phosphonoalkylated, sulphoxylated or phosphorylated, causing the SAP to be highly hydrophilic. Such modified polymers also may be cross-linked to reduce their water-solubility.

The ability of a super absorbent material to absorb liquid is dependent upon the form, position and/or manner in which particles of the super absorbent material are incorporated into the fibrous web of the absorbent core. Whenever a particle of the super absorbent material is wetted, it swells and forms a gel. Gel formation can block liquid transmission into the interior of the absorbent core, a phenomenon called “gel blocking.” Gel blocking prevents liquid from rapidly diffusing or wicking past the “blocking” particles of super absorbent, causing portions of a partially hydrated core to become inaccessible to multiple doses of urine. Further absorption of liquid by the absorbent core must then take place via a diffusion process. This is typically much slower than the rate at which liquid is applied to the core. Gel blocking often leads to leakage from the absorbent article well before all of the absorbent material in the core is fully saturated.

Despite the incidence of gel blocking, super absorbent materials are commonly incorporated into absorbent cores because they absorb and retain large quantities of liquid, even under load. However, in order for super absorbent materials to function, the liquid being absorbed in the absorbent structure must be transported to unsaturated super absorbent material. In other words, the super absorbent material must be placed in a position within the disposable absorbent article to be contacted by liquid. Furthermore, as the super absorbent material absorbs the liquid it must be allowed to swell. If the super absorbent material is prevented from swelling, such as by being tightly constrained within the fibrous web or by pressure exerted by the swelling of adjacent super absorbent particles, it will cease absorbing liquids.

Various devices and methods are known in the art for distributing particulate material, such as SAP, to a moving web for the manufacture of absorbent cores for disposable absorbent articles such as discussed above. In some cases, a fibrous web of the tow/SAP core may be treated with a tackifying agent to adhere the SAP particles to the fibrous web. In other cases, the SAP particles may be introduced into the fibrous web without any adhesive, binder or tackifying agent, such as is disclosed in U.S. Pat. No. 6,068,620 issued to Chmielewski et al. Such a construction has been referred to as a dry-formed composite (DFC) core. A DFC core may be surrounded by a tissue layer or multiple tissue layers to form a DFC laminate structure that contains the fibrous web and SAP.

Some known processes for creating a conventional fluff pulp/SAP core use a large forming chamber to blend the SAP with the fluffed pulp, then convey this blend onto a drum or screen by using a vacuum. The drum or screen has forming pockets that form the fluff pulp/SAP material into the desired shape and the formed cores then are deposited for integration into absorbent products. Such methods can be inefficient during startup and transitions in the manufacturing line speed because a relatively large amount of time can be required to provide a stabilized mixture of SAP and fluff pulp, which can thus result in the creation of a number of scrap products until stabilization. Other conventional processes for forming fluff pulp/SAP cores immerse the fluffed pulp in a fluid mixture containing SAP particles, then dry the fluff pulp/SAP mixture before integration into the absorbent article. Such wet forming processes can typically require more manufacturing steps and can be more expensive than dry forming methods.

Various systems for distributing SAP onto a moving web are known in the art. Some use fixed-size moving mechanical gates that provide a uniform amount of SAP to the absorbent core, such as disclosed in U.S. Pat. No. 6,139,912 (Onuschak et al.). Although such devices may be suitable for providing an even flow of SAP or other powdered and particulate additives to absorbent cores, relatively complex feeding machinery can be required, including a rotary valve that uses a pneumatic SAP conveyor to return undistributed SAP back to a supply container. Pneumatic conveyors can typically require a relatively long time to become pressurized and to convey the SAP, which can result in inefficiencies during transitional phases, such as when the machine operating speed varies, or during start-up and shut-down, or when it is desired to change the amount of SAP being fed to the absorbent core. The additional parts of such feeders can also be expensive and can further be subject to wear and other service related problems. Similar such devices are disclosed in U.S. Pat. No. 4,800,102 (Takada).

Other conventional systems for distributing particulate materials are known to use pneumatic particle projectors that use pressurized gas to convey the SAP to the surface of the absorbent core. Such devices are disclosed, for example, in U.S. Pat. No. 5,614,147 (Pelley) and U.S. Pat. No. 5,558,713 (Siegfried et al.). Such systems can rely upon relatively complex air conveyors that may be susceptible to blockage and may not efficiently accommodate as wide a variety of particulate, powder and fibrous materials as other systems due to their relatively small passage sizes. Additionally, the compressed air used in such pneumatic conveyors can be subject to contamination with oil that may cause blockage, SAP degradation, and other problems. Such systems may also require a relatively long time to stabilize, leading to inefficiencies during transitional phases. Various other types of known systems for distributing particulate material can be disadvantageous for a number of reasons, which can include problems with local concentrations and shortages of SAP, and also a general inability to control the process as accurately as desired to provide concentrations and shortages of SAP when desired. Additionally, such systems may not be sufficiently controllable to accurately provide reduced SAP amounts that are necessary during transitional phases, leading to improperly loaded cores during such phases of operation.

Another example of a particulate material distribution system, including delivery/distribution of SAP onto a moving web, is described in U.S. Patent Application Publication No. US 2005/0215962 (Litvay, et al.), which is hereby incorporated herein by reference.

A further example of system for applying particulate material to a moving web is disclosed in U.S. Pat. No. 7,235,278 (Fung et al.), which discloses, referring to the Abstract thereof: “A method and apparatus of applying a particulate material to a substrate includes applying adhesive to the substrate and passing the substrate through a chamber in which a particulate material is suspended in a fluid in order to adhere the particulate material to the substrate.” This patent describes the application of particulate material, which can include “superabsorbent powder,” to fibrous substrates during the manufacture of disposable absorbent articles, including feminine hygiene articles such as sanitary napkins, tampons and panty liners, as well as diapers and incontinence articles. Other types of conventional particulate material distribution systems are described in this patent, including a system in which a fluid-absorbing powder can be applied to a moving fibrous substrate, wherein the super absorbent powder is thereby transferred to the surface of the fibrous material or regions within the fibrous material, thus enhancing the absorbent properties of the fibrous substrate. This type of process is described as the application of particulate materials to the substrate being accomplished by any of a number of known conventional means, including using mechanical delivery devices such as conduits, nozzle sprayers, and the like, to apply the particulate material to the substrate.

As further described in this patent, such conventional conduits, nozzles, and the like to deliver particulate material to a substrate, particularly a substrate moving at a high speed, is subject to variety of problems. It can be difficult to apply the particulate material to a predetermined, localized area of the substrate—if the spraying of the powder is not initiated and terminated within a tightly defined time interval, the particulate may be delivered to undesired locations rather than the desired location on the substrate. Furthermore, the particulate material can often be subject to spreading, i.e., the particulate does not remain localized on the substrate, and the particulate may migrate to locations where it is not desired, thereby contaminating the process and/or failing to provide the desired amount or density of the particulate material at the preferred location on the substrate. These problems can be compounded for moving substrates, including fibrous substrates, which are often processed at line speeds that are fast enough to promote scattering of the particulate to undesired locations on the substrate.

The apparatus described in U.S. Pat. No. 7,235,278 purports to overcome some of the challenges associated with known systems for distributing particulate material onto a moving web. However, similar to some of the other more complex systems described previously, the apparatus in this patent can also add undesirable cost and/or complexity to the manufacturing process.

Therefore, a need exists for an apparatus and method for distributing particulate material onto a moving web during the manufacture of disposable absorbent articles which can provide simpler, more effective solution than heretofore known.

### SUMMARY

An apparatus and method for distributing particulate material onto a moving web during the manufacture of disposable absorbent articles are described hereinafter, in which an embodiment of the apparatus for distributing particulate material onto a moving web can generally comprise a particulate delivery manifold for distributing particulate material onto a target area of a web moving in a first direction. More particularly, the particulate delivery manifold can generally comprise a hopper for receiving a supply of particulate material and a plurality of tubular members each having an inlet end communicating with the hopper, and an outlet end for discharging the particulate material from the hopper onto the target area. The plurality of separate tubular members thus define a plurality of separate flow paths through which to discharge the particulate material onto the moving web. Each of the tubular members can extend downwardly from the bottom of the hopper in a generally parallel fashion, and at an angle toward the web. The manifold can also be positioned with respect to the moving web such that the particulate material will be discharged onto the moving web in the same direction as the web is moving. Each inlet end of the tubular members can be connected at the bottom of the hopper, and can be positioned adjacent each other and parallel to a first axis. The tubular members can be bent so as to extend downwardly from the hopper at an angle toward the moving web as described above, and additionally can be bent, or formed, into a configuration wherein each of the outlet ends are disposed adjacent each other and parallel to a second axis. This second axis can be generally perpendicular to the first axis along which the inlet ends are generally aligned, but can be generally parallel to a lateral axis of the moving web, which corresponds to the width of the web. In this way, the combined width of the adjacently positioned generally parallel outlet ends of the manifold are generally aligned with the width of the moving web, which facilitates more evenly distributing the particulate material across the width of the web as it is discharged from the manifold. Moreover, the width of the outlet ends of the manifold can also be sized to generally approximate a predetermined width of the target area. As such, an even distribution of the particulate material across the width of the target area on the moving web is better facilitated. The target area can correspond to the location of an absorbent core on the moving web onto which SAP is desired to be applied. As a result, the angle and configuration of the downwardly extending tubular members, as well as the width and orientation of the outlet openings, with respect to the lateral axis of the web, can be designed to discharge the particulate material downwardly toward the target area, and in the (first) direction in which the web is moving. All of this can facilitate a more even distribution of the particulate material onto the absorbent core component of the disposable absorbent article which is being manufacture in this manner.

An alternative embodiment can more generally comprise be a particulate delivery device for distributing particulate material onto a target area of a web. Similarly to the particulate delivery manifold, the particulate delivery manifold can generally comprise a hopper for receiving a supply of particulate material, but can differ in that a single specially designed tubular member can be used. The tubular member can having an inlet end communicating with the hopper, and an outlet end for discharging the particulate material from the hopper onto the target area. The hopper can be the same as for the particulate delivery manifold. The outlet end of the single tubular member can be shaped in the form of an elongated slot, e.g., a slot having a height and a width wherein the width is substantially greater than the height. The size of the slot shaped outlet opening can generally correspond width of the target area, and can be aligned along the same lateral axis as the width of the target area, as discussed above with regard to the combined width of the outlet openings on the multiple tubular members of the particulate delivery manifold. Thus, as explained above, this shape can facilitate the more even distribution of particulate material across the width of the absorbent core, which can correspond to the target area on the moving web. In particular, the target area has a predetermined width, and the width of the outlet end can be sized to approximate that predetermined width such that an even distribution of the particulate material across the width of the target area, e.g., the absorbent core, is facilitated. Similarly to the plurality of tubular members of the particulate delivery manifold, the single tubular member of the particulate delivery device can have the same downwardly extending configuration, being bent at the same angle with respect to the moving web such that the particulate material is discharged downwardly toward the target area and in the same direction which the web is moving. The inlet opening of the particulate delivery device can also have an elongated slot shape having a width substantially greater than a height thereof, and wherein the width of the inlet end is oriented along a second axis, similarly to the outlet opening. As mentioned above, this second axis can be generally perpendicular to the aforesaid first axis. Additionally, the single tubular member can have a cross section in the shape of an elongated slot with a width greater than a height thereof, similarly to the inlet and outlet openings. In a further embodiment of the particulate delivery device, at least one partition can be provided, positioned within the tubular member at or near the outlet end. The partition, or multiple partitions, could extend the entire length of the tubular member, e.g., from the inlet opening to the outlet opening, or may only extend a portion of that length, and just terminate somewhere near the outlet end. Whatever the design, the one or more partitions can define a plurality of separate flow paths near the outlet opening of the tubular member such that the particulate material can be discharged toward the moving web in a plurality of separate streams of particulate material.

Consistent with the heretofore described embodiments of a manifold, or device, for distributing particulate material onto a moving web, an associated method for distributing particulate material onto a moving web can generally comprise discharging the particulate material onto a target area on the moving web as a plurality of separate streams of the particulate material. The plurality of separate streams of particulate material can be discharged onto the target area in the same direction as the web is moving. The plurality of separate streams of particulate material can also be discharged adjacent to each other, wherein the (combined) width of the adjacent streams is oriented generally along the aforesaid lateral axis of the web. Moreover, the combined width of the adjacent streams can also approximate the width of the target area on the moving web, which target area can correspond to the location of the absorbent core. In this way, as explained previously, the more even distribution of particulate material across the width of the absorbent core is facilitated.

Certain illustrative aspects of the apparatus and method for distributing particulate material onto a moving web during the manufacture of disposable absorbent articles are described herein in connection with the following description and the appended drawings. These aspects may be indicative of but a few of the various ways in which the principles of the apparatus and method for distributing SAP into such disposable absorbent articles, and more particularly into the absorbent core component of such articles, during the manufacture thereof may be employed, and which is intended to include all such aspects and any equivalents thereof. Other advantages and features of the apparatus and method for distributing particulate material onto a moving web during the manufacture of disposable absorbent articles may become apparent from the following detailed description, when considered in conjunction with the appended drawing figures.

### BRIEF DESCRIPTION OF THE DRAWING FIGURES

A more complete understanding of the apparatus and method for distributing particulate material onto a moving web during the manufacture of disposable absorbent articles during the manufacture of disposable absorbent articles can be obtained by considering the following description in conjunction with the accompanying drawings, in which:

FIG. 1 is a perspective view of a prior art particulate delivery apparatus.

FIG. 2 is a perspective view of an embodiment of a particulate delivery apparatus.

FIG. 3 is an elevation view of an embodiment of a portion of a system for manufacturing an absorbent article.

FIG. 4 is a plan view of the system illustrated in FIG. 3.

FIG. 5 is an elevation view of an embodiment of a particulate delivery apparatus.

FIG. 6 is a plan view of the particulate delivery apparatus in FIG. 5.

FIG. 7 is an end view of the particulate delivery apparatus in FIG. 5.

FIGS. 8 is an embodiment of a mesh catch grate for the particulate delivery apparatus in FIG. 5.

FIG. 9 is an elevation view of an alternative embodiment of a particulate delivery apparatus.

FIG. 10 is a plan view of the particulate delivery apparatus in FIG. 9.

FIG. 11 is an end view of the particulate delivery apparatus in FIG. 9.

FIGS. 12 is an embodiment of a mesh catch grate for the particulate delivery apparatus in FIG. 9.

FIG. 13 is a plan view partially in section of another alternative embodiment of a particulate delivery apparatus.

### DESCRIPTION OF CERTAIN EMBODIMENTS

As used herein, the terms “absorbent article” or “absorbent garment,” or simply “article” or “garment,” refers to articles that absorb and contain exudates, and more specifically, refers to articles that are placed against or in proximity to the body of the wearer to absorb and contain the various exudates discharged from the body. A non-exhaustive list of examples of absorbent articles includes diapers, diaper covers, underpads, disposable diapers, training pants, feminine hygiene products and adult incontinence products. The term absorbent article includes all variations of absorbent garments, including disposable absorbent garments that are intended to be discarded or partially discarded after a single use (i.e., they are not intended to be laundered or otherwise restored or reused) and unitary disposable absorbent garments that have essentially a single structure (i.e., do not require separate manipulative parts such as a diaper cover and insert). As used herein, the term diaper refers to an absorbent article worn by infants and incontinent persons about the lower torso.

Although a “disposable” absorbent article is typically referred to, a “disposable” absorbent article may be intended to be either fully or only partially discarded after a single use. Thus, “disposable” articles can comprise a single inseparable structure, in which the entire article is disposable, or may also comprise articles having replaceable inserts or other interchangeable parts, in which only those inserts or interchangeable parts are disposable.

Absorbent articles and diapers may have a number of different constructions. These constructions typically have an absorbent core disposed between a liquid pervious, body-facing topsheet, and a liquid impervious, exterior facing backsheet. One or both of the topsheet and backsheet may be shaped to form a pant-like garment. The topsheet, backsheet and absorbent core may also be formed as a discrete assembly that is placed on a main chassis layer that is shaped to form a pant-like garment. In the usual case, the SAP would be mainly disposed in, on, or adjacent to the absorbent core, and the absorbent core itself can be comprised of multiple different layers, any of which may have SAP associated therewith. The garment may be provided to the consumer in the fully assembled pant-like shape, or may be partially pant-like and require the consumer to take the final steps necessary to form the final pant-like shape. In the case of training pant-type garments and most adult incontinent products, the garment is provided fully formed with factory-made side seams and the garment is donned by pulling it up the wearer's legs. In the case of diapers, a caregiver wraps the diaper around the wearer's waist and joins the side seams manually by attaching one or more adhesive or mechanical tabs, thereby forming a pant-like structure.

The term “component” can refer, but is not limited, to designated selected regions, such as edges, corners, sides or the like; structural members, such as elastic strips, absorbent pads, stretchable layers or panels, layers of material, or the like; or a graphic, embossed pattern, or the like.

The term “disposed” and the expressions “disposed on,” “disposing on,” “disposed in,” “disposed between” and variations thereof (e.g., a description of the article being “disposed” is interposed between the words “disposed” and “on”) are intended to mean that one element can be integral with another element, or that one element can be a separate structure bonded to or placed with or placed near another element. Thus, a component that is “disposed on” an element of the absorbent article can be formed or applied directly or indirectly to a surface of the element, formed or applied between layers of a multiple layer element, formed or applied to a substrate that is placed with or near the element, formed or applied within a layer of the element or another substrate, or other variations or combinations thereof.

The terms “top sheet” and “back sheet” denote the relationship of these materials or layers with respect to the absorbent core. It is understood that additional layers may be present between the absorbent core and the top sheet and back sheet, and that additional layers and other materials may be present on the side opposite the absorbent core of either the top sheet or the back sheet.

The expression “fibrous material” denotes any fibrous material that may be used in an absorbent garment, including without limitation, various hardwood and softwood fluff pulps, tissues, cottons, and any other fibrous materials described herein. “Fibrous material” used in the context of the present invention is not intended to limit the invention to any particular type of fibrous material.

Though different in appearance and dimensions, all of the various types of absorbent articles listed previously can generally perform the same basic function of fluid absorption and retention and can all be generally based upon the same fundamental technology. Nearly all of these types of absorbent articles are comprised of a top sheet, a back sheet, and an absorbent core disposed between the top sheet and back sheet. The absorbent core is conventionally located within the article at a position to receive bodily fluids. Optionally, a fluid acquisition layer may also be disposed between the top sheet and the absorbent core.

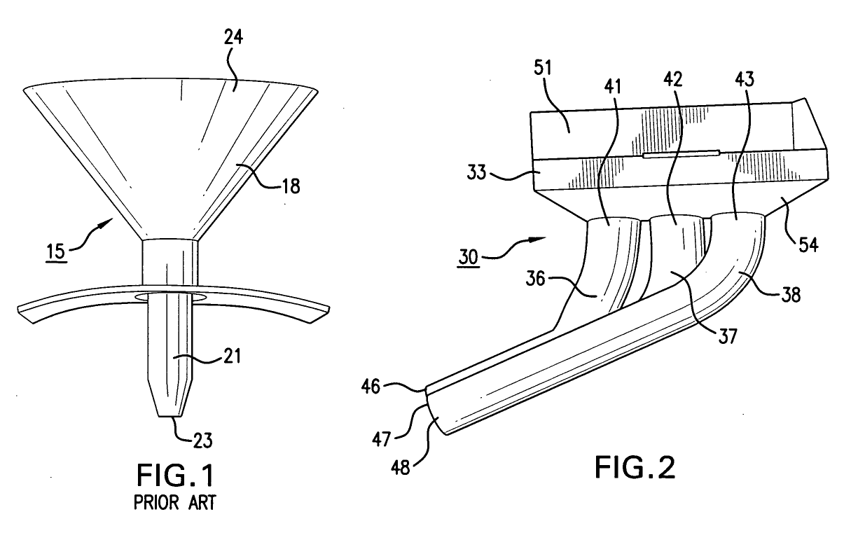

Referring now to the drawing figures wherein like reference numerals are used to refer to like elements throughout, a prior art particulate delivery funnel 15 for applying particulate material, for example SAP, onto a moving web 32 of material during the manufacture of disposable absorbent articles containing such particulates is illustrated in the perspective view of FIG. 1. In a particular application associated with the embodiment shown in FIG. 1, the prior art funnel illustrated can have been commonly utilized as part of either an auger driven or vibratory delivery system which delivers bulk SAP to the funnel 15 for distributing the SAP onto a moving web during the manufacture of disposable absorbent article, for example a training pant.

As shown, the prior art funnel 15 can basically consist of a conventional type of funnel having an upper portion, or “hopper” 18 for receiving and/or temporarily storing a quantity of SAP material, and a lower tubular portion 21 connected to the bottom of the hopper. The tubular portion 21 can commonly taper from a larger diameter where it connects to the hopper 18 to a smaller outlet opening 23 from which the SAP is discharged onto the moving web. The hopper 15 can also be generally “funnel” shaped having a relatively large top opening 24 to receive the particulate material. The size of the hopper 18 can gradually decrease in the direction of the lower tubular portion 21 connected at the bottom thereof. In the present context, the term “hopper” is commonly defined as “a funnel-shaped chamber or bin in which loose material is stored temporarily, being filled through the top and dispensed through the bottom.”

As mentioned above, the SAP material can be delivered into the funnel 15 by either auger or vibratory feeder systems. Auger and vibratory feeder systems are well known in the art and are not shown in the drawings or discussed in detail in this application. One of ordinary skill in the art would understand the structure and operation of either auger or vibratory feeder systems for delivering the particulate material to the funnel 15, or other types of funnels and/or particulate delivery devices as described hereinafter.

Conventionally, the outlet 23 would be positioned adjacent the moving web of material onto which the SAP material would be discharged during manufacture of the disposable absorbent article which, in this particular application, can be a training pant as mentioned previously. The lower tubular portion 21 of the funnel 15 can typically be positioned generally perpendicular to the moving web, such that the particulate material is discharged generally perpendicular to the moving web. During a manufacturing run the SAP would be continuously delivered (by the vibratory or auger feed systems) into the top opening 24 of the hopper 18. From there, by gravity feed for example, the SAP would be discharged through the outlet opening 23 onto the moving web of material, and more particularly onto a target area on the moving web which would generally correspond to the location of an absorbent core component. The outlet opening 23 would commonly be positioned with respect to the moving web, so as to be generally over the longitudinal centerline of the moving web such that the particulate material would be discharged primarily onto the center of the articles, which is where the target area, i.e., the absorbent core, would typically be located.

There can be some known disadvantages encountered with this system, such as, for example, problems obtaining an even distribution of SAP throughout the absorbent core of the disposable absorbent garment manufactured according to this system. If the SAP could be better targeted onto the target area, an improved distribution of SAP throughout the absorbent core could be obtained. Tests have indicated that a stable SAP attainment throughout the absorbent core can greatly improve the performance of the core. Such tests can include, for example, initial wetting and rewet tests, such as performed in a product test lab. A more even distribution of SAP across the absorbent core can provide more efficient fluid absorption and retention within the core, and can give improved performance, especially in values for rewet. Better targeting of the SAP onto the absorbent core can also enable a reduction in the amount of SAP needed in the core because the SAP can be more accurately distributed at the optimum locations desired.

Certain conditions can be associated with manufacturing processes which distribute particulate material onto a moving web that make attainment of an even distribution across the absorbent core difficult. Such conditions can include, for example, air movement across the moving web, airflow in the direction of the movement of the web, such as is created by the movement of the web itself. [Is this what is meant by “air movement across the web 32” or is this different? For now, I am assuming it is different]. These conditions present challenges to consistently targeting the distribution of SAP particles onto the moving web, i.e., onto the absorbent core, and providing an even distribution of SAP particles across the absorbent core.

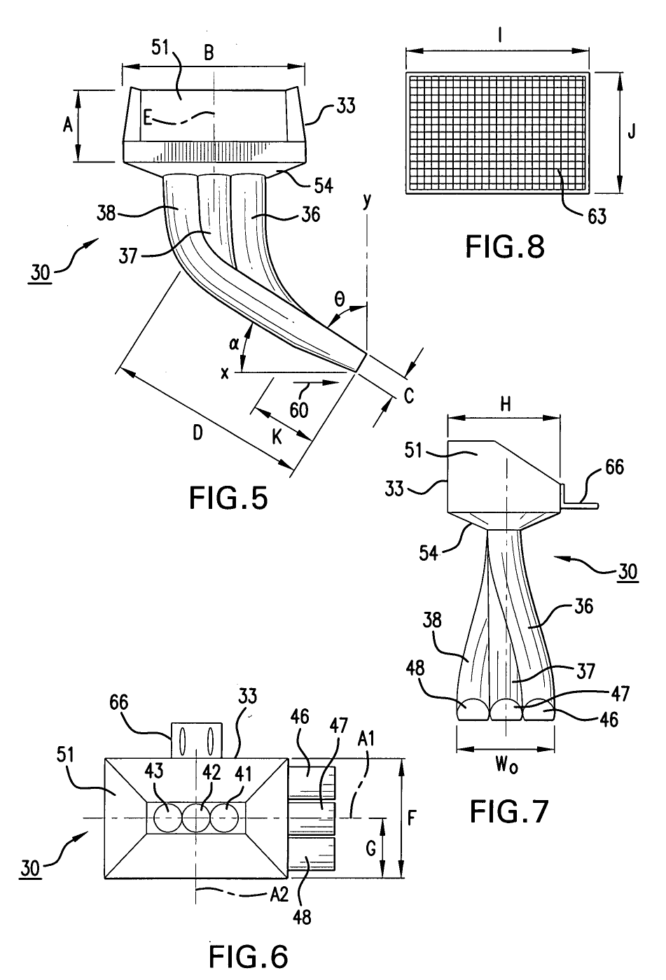

Turning now to FIGS. 2 through 8, an embodiment of an apparatus for distributing particulate material onto a moving web 32 during the manufacture of disposable absorbent articles is illustrated. Referring particularly to FIGS. 2 through 4, the apparatus can be a particulate delivery manifold 30 for distributing particulate material onto a target area 31 of a web 32 moving in a first direction 60. The particulate delivery manifold 30 can generally comprise a hopper 33 for receiving a supply of particulate material, and a plurality of tubular members 36, 37, 38 each having an inlet end 41, 42, 43 connected at the base 54 of the hopper 33, and an outlet end 46, 47, 48 for discharging the particulate material from the hopper 33 onto the target area 31. The plurality of separate tubular members 36, 37, 38 thus define a plurality of separate flow paths through which to discharge the particulate material onto the target area 31 on the moving web 32. As explained above, this target area 31 can correspond to the location on the moving web 32 at which the absorbent core component of the absorbent article would be positioned.

The hopper 33 can have a top opening 51 which can be configured to receive particulate material, e.g., SAP, from a supply thereof. For example, in a process for manufacturing training pants a vibratory feeder (not shown) can be employed as part of the system for providing the SAP to the manifold. This can be in a manner similar to the system using a vibratory feeder as disclosed in the aforementioned U.S. Patent Application Publication No. US 2005/0215962 (Litvay, et al.) which is incorporated herein by reference.

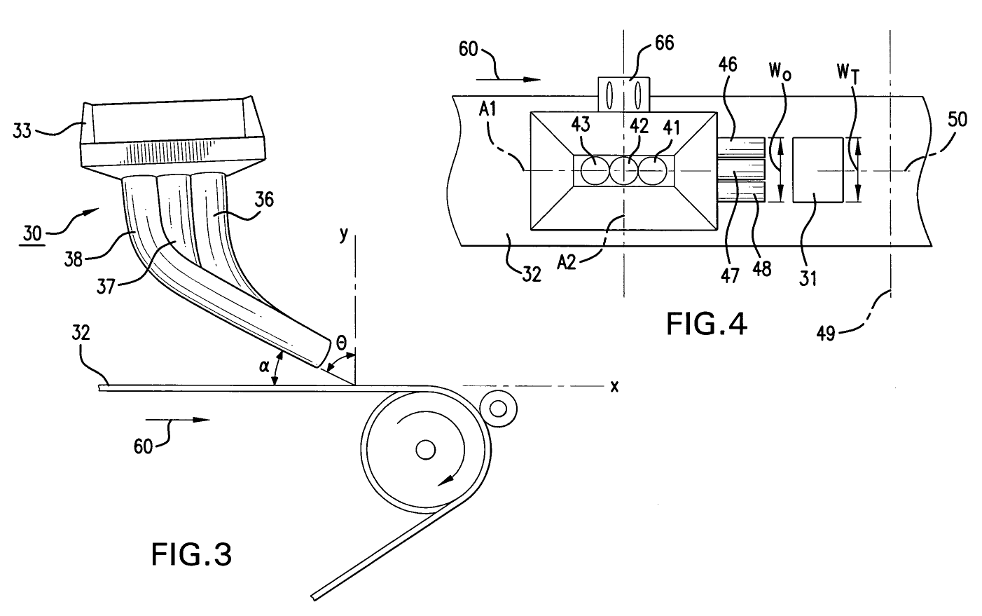

Each of the tubular members 36, 37, 38 can extend downwardly from the base 54, or bottom, of the hopper 33 at an angle to the moving web 32. The tubular members 36, 37, 38 can be formed generally parallel to each other. As illustrated in FIGS. 3 and 4, the manifold 30 can be positioned with the outlet ends 46, 47, 48 of the manifold 30 above and adjacent to the web 32 such that the SAP would be discharged downwardly onto the web 32 at an angle. The manifold 30 can also be positioned with respect to the moving web 32 such that the particulate material will be discharged in the same (first) direction 60 that the web 32 is moving, albeit at a downwardly sloping angle, denoted by angle α, if measured from a horizontal axis X, or the angle θ, if measured from a vertical axis Y. Thus, the particulate material will be discharged toward the moving web 32 with some component of direction/velocity which is in the same direction 60 as the web 32 is moving. The particular angle α, or θ, of the tubular members at which the particulate material will be discharged from the manifold 30 toward the moving web 32 can be, for example, about 30 degrees from X, or 60 degrees from Y. However, the particular angle α, or θ, at which the particulate material is discharged from the manifold 30 with respect to the moving web 32 can vary according to different design factors. Some of the relevant factors and considerations of the angle α, or θ, at which the particulate material is discharged toward the moving web 32 are discussed, for example, in paragraph [0167] of the aforesaid U.S. Patent Application Publication No. US 2005/0215962.

In further embodiments of the manifold 30, each inlet end 41, 42, 43 of the tubular members 36, 37, 38 can be connected to the hopper 33, such as at the bottom 54 thereof, and each of the inlet ends 41, 42, 43 can be positioned adjacent to each other, and generally parallel to a first axis A1, which can generally correspond to the longitudinal axis 50 of the web 32. The plurality of tubular members 36, 37, 38 can be bent so as to extend downwardly from the bottom 54 of the hopper 33 at a desired angle (as discussed above) toward the moving web 32. In addition, the downwardly extending generally parallel tubular members 36, 37, 38 can be bent, or formed, into a configuration wherein the outlet ends 46, 47, 48 are disposed adjacent each other and generally parallel to a second axis A2. As can be seen, the second axis A2 can be generally perpendicular to the first axis A1. In this way, the combined width W_{O} of the adjacently positioned generally parallel outlet ends 46, 47, 48 of the manifold 30 is generally aligned with the lateral axis 49 of the moving web 32. This is thought to possibly facilitate more evenly distributing the particulate material across the width of the web 32, and particularly the width W_{T} of the target area 31, as it is discharged from the manifold 30. Moreover, the width W_{O} of the outlet ends 46, 47, 48 of the manifold 30 can also be sized to generally approximate a predetermined width W_{T} f the target area 31, which can correspond to the absorbent core of the disposable absorbent article being manufactured. As such, an improved, more even distribution of the particulate material across the width W_{T} of the target area 31 on the moving web 32 can be facilitated.

The angle α, or θ, and the configuration of the downwardly extending tubular members 36, 37, 38, as well as the width W_{O} and orientation of the outlet openings 46, 47, 48, with respect to the lateral axis 49 of the web 32, can be designed to discharge the particulate material downwardly toward the target area 31, and in the same (first) direction 60 in which the web 32 is moving. One, or a combination of, of these features are believed to facilitate a more even distribution of the particulate material onto the absorbent core component of the disposable absorbent article which is being manufactured in this manner.

Further embodiments of the particulate manifold 30 can comprise a mesh catch grate 63 disposed in the hopper, over top of the inlet openings 41, 42, 43 of the tubular members 36, 37, 38. The mesh catch grate 63 can be provided to filter any over-sized or clumped particulate material. A bracket 66 can also be provided for mounting the manifold 30 in a desired location with respect to the moving web 32 and other components of an overall system (not shown) in which the manifold 30 can be employed.

In the drawings, various dimensions of the manifold 30 are denoted by reference letters in the drawing figures. In an exemplary embodiment of the manifold 30, these dimensions can approximately be, just by way of example, as set forth below:

| | | |
|---|---|---|
| A = | 3.25 | in.; |
| B = | 8.00 | in.; |
| C = | 1.063 | in;. |
| D = | 10.00 | in.; |
| E = | 4.00 | in.; |
| F = | 5.00 | in.; |
| G = | 2.50 | in.; |
| H = | 5.00 | in.; |
| I = | 7.75 | in.; |
| J = | 4.875 | in.; |
| K = | 3.00 | in.; and |

| | |
|---|---|
| W1 = | ; and |
| W2 = | in. |

Notwithstanding the (approximate) dimensions listed above, it is to be understood that the manifold 30 can be designed for use with different systems in which the same function is utilized, but in which the different systems can require the manifold 30 to be positioned at different places in the system, and may also require a larger or smaller manifold 30. Accordingly, the listed dimensions are provided by way of example only, and all of the listed approximate dimensions are subject to change for different applications of the manifold 30.

Tests have shown that the particulate delivery manifold 30 enables both improved targeting of SAP on the absorbent core and also more evenly distributes the SAP across the absorbent core. These improvements result in more efficient fluid absorption by the core, and which also enables a reduction in the amount of SAP needed in the absorbent core. Without intending to be bound thereby, it is theorized that the improved performance of the manifold 30 can be attributed to one or multiple factors. In particular, for example, the exit openings 46, 47, 48 can be arranged in parallel along axis A2 which can generally correspond to the lateral axis 49 of the absorbent article, and the exit openings 46, 47, 48 can also have a width W_{O} generally equal to the width W_{T} of the target area 31. In this way the SAP can be more evenly distributed across the absorbent core as it is discharged from the manifold 30. The width W_{O} of the exit openings 46, 47, 48 can thus enable better targeting of the SAP onto the portions of the moving web 32, e.g., the target area 31, which can thus reduce the total amount of SAP that need be distributed.

Other aspects of the manifold 30 that may contribute to the improved delivery of the SAP may be that the exit openings 46, 47, 48 also discharge the SAP in the direction 60 of the moving web 32. Moreover, the particulate material can be discharged onto the moving web 32 as a plurality of separate streams of material. The prior art funnel 15 discharges the particulate material generally perpendicular to the moving web 32, and as a single stream of particulate material. In contrast, the tubular members 36, 37, 38 of the particulate delivery manifold 30 are angled so as to discharge the SAP in a direction not only downward onto the web 32, but also somewhat parallel to the web 32. The component of the angle of discharge which is parallel to the web 32 thus results in the particulate material being imparted with at some component of velocity in the same direction 60 as the web 32 is moving. This may have the effect of ameliorating otherwise disruptive effects of air movement across the web 32 and/or airflow in the same direction as the web 32 is moving, which can facilitate the more even distribution of SAP across the target area 31/absorbent core. For example, the airflow out from the manifold 30 is directed more in parallel to the movement of the web 32, and thus the SAP material, and the associated airflow out of the exit openings 46, 47, 48 of the manifold 30, flows more parallel with the airflow along the longitudinal axis 50 of the moving web 32. In contrast, the prior art funnel 15 was oriented at generally a 90 degree angle to the moving web 32, such that turbulence would likely be created at intersection of the airflow from the funnel 15 with the airflow created by the moving web 32.

Additionally, discharging the particulate material onto the moving web 32 as the plurality (e.g., three as illustrated) of separate streams of particulate material may possibly result in more favorable conditions with respect to the disruptive airflow at the surface of the moving web 32, which can further contribute to providing a more even distribution of SAP across the target area 31/absorbent core. For example, the separate streams may possibly also contribute to improved air flow characteristics in regard to reducing any problems, as mentioned above, relating to turbulence and/or other disadvantageous airflow conditions across the web 32 and/or in the same direction as the web 32 is moving.

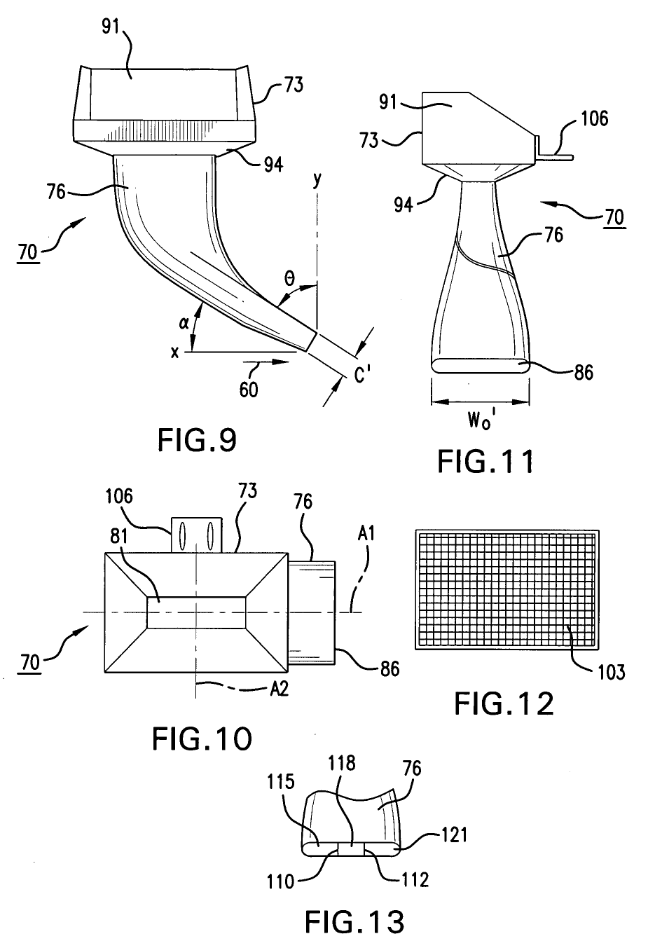

Referring now to FIGS. 9 through 12, there is illustrated a further embodiment of a particulate delivery device 70 for distributing material onto a moving web 32 of material during the manufacture of disposable absorbent articles. As shown, the particulate delivery device can be basically the same as the particulate delivery manifold 30, with the exception of the design of the lower tubular portion 76 which directs the particulate material from the hopper 73 onto the moving web 32. Similarly to the particulate delivery manifold 30, the particulate delivery device can generally comprise a hopper 73 for receiving a supply of particulate material, but can differ in that a single tubular member 76 having a specially formed shape can instead be provided. The tubular member 76 can have an inlet end 81 communicating with the hopper 73, and an outlet end 86 for discharging the particulate material from the hopper 73 onto a target area 31 on the moving web 32. As described previously, the hopper 73 can have a top opening 91 which can be configured to receive SAP from a supply thereof. The hopper 73 for the particulate delivery device 70 can be the same as the hopper 33 described in connection with the particulate delivery manifold 30 shown in FIGS. 2 through 8. Likewise, as shown in FIG. 12, a mesh catch grate 103 can be employed which can be the same as the mesh catch grate 63 described in connection with the particulate delivery manifold 30.

The outlet end 86 of the single tubular member 76 can be shaped in the form of an elongated slot, e.g., a slot having a height H′ and a width W_{O}′, wherein the width W_{O}′ is substantially greater than the height H′. The size of the slot shaped outlet opening 86 can generally correspond to the overall size of the plurality of adjacently disposed outlet openings 46, 47, 48 of the particulate delivery manifold 30 described previously. Moreover, the width W_{O}′ of the elongated slot can also be oriented the same way, i.e., along the same axis A2 that generally corresponds to the lateral axis 49 of the moving web 32. In this way, as described previously, the width W_{O}′ of the outlet opening 86 can be sized to generally approximate to the width of the moving web 32, or more particularly, the width W_{T} of the target area 31 which can correspond to the width of the absorbent core. Thus, the shape of the outlet opening 86 can facilitate the more even distribution of particulate material across the width of the absorbent core. More particularly, the target area 31 can have a predetermined width W_{T}, and the width W_{O}′ of the outlet end 86 can be sized to approximate W_{T}. Thus, an even distribution of the particulate material across the width W_{T} of the target area 31/absorbent core is facilitated.

Similarly to the plurality of tubular members 36, 37, 38 of the particulate delivery manifold 30 described previously, the single tubular member 76 of the particulate delivery device 70 can have the same downwardly extending, angled configuration, i.e., being bent at the same angle α, or θ, with respect to the moving web 32 such that the particulate material is discharged downwardly toward the target area 31 and in the same (first) direction 60 in which the web 32 is moving.

Additionally, similarly to the outlet opening 86, the inlet opening 81 of the particulate delivery device 70 can also have the same or similar elongated slot shape, having a width substantially greater than a height thereof, and wherein the width of the inlet end is oriented along the axis A1. Axis A1 can be generally perpendicular to the aforesaid axis A2 which, as previously explained, can generally correspond to the lateral axis 49 of the web 32. Moreover, in the embodiment illustrated, the single tubular member 76 itself can have a cross section also generally having the shape of an elongated slot with a width greater than a height thereof, similarly to the inlet 81 and outlet 86 openings. However, since the configuration into which the single tubular member 76 must be formed (or bent) in a complex shape, the cross section shape may not be identically shaped and/or sized along the entire length of the tubular member 76.

Turning now to FIG. 13, in a further embodiment of the particulate delivery device 70, one or more partitions 110, 112 (two shown) can be provided, positioned within the tubular member 76 at or near the outlet end 86. The partitions could extend the entire length of the tubular member 76, e.g., from the inlet opening 81 to the outlet opening 86, or may only extend a portion of that length. Generally, the partitions 110, 112 can terminate at or near the outlet end 86. However far the partitions 110, 112 extend along the interior of the tubular member 76, the one or more partitions 110, 112 can define a plurality of separate flow paths 115, 118, 121 through which the particulate material can be discharged onto the moving web 32 as a plurality of generally separate streams of particulate material.

Overall, embodiments of the particulate material delivery device 70 illustrated in FIGS. 9 through 13 can be essentially the same functionally as the particulate material delivery manifold 30 shown in FIGS. 2 through 9, except that a single tubular member 76 can be utilized instead of a plurality of tubular members 36, 37, 38. However, the single tubular member 76 can have an overall configuration, in terms of the shape of the inlets 81 and outlets 86, the angle with respect to the moving web 32, and the provision of multiple separate flow paths 115, 118, 121, which can be substantially the same as the particulate delivery manifold 30 with a plurality of tubular members 36, 37, 38. As such, the same benefits of better distributing the SAP more evenly over the target area 31/absorbent core can be provided.

In general, it is to be understood that differently shape inlet and/or outlet openings can alternatively be provided for either the particulate delivery manifold 30 or the particulate delivery device 70, if desired. In particular, the shape and dimensions of the inlet 81 and/or outlet 86 openings can vary. The shape and/or size of the single tubular member 76 can also be specially configured depending upon various factors, including, for example, the desired target area 31, e.g., size and/or location, on the moving web 32 onto which the SAP is desired to be distributed, and/or airflow characteristics which can be affected by the shape of the outlet opening 86 in particular.

Consistent with the heretofore described embodiments of the particulate delivery manifold 30, and the particulate delivery device 70, for distributing particulate material onto a moving web 32, an associated method for distributing particulate material onto a moving web 32 will now be described. An embodiment of such a method for distributing particulate material onto web 32, or a target area 31 thereon, which is moving in a first direction generally comprise discharging the particulate material onto the moving web 32/target area 31 as a plurality of separate streams of the particulate material. Additionally, the plurality of separate streams of particulate material can be discharged in the same (first) direction 60 as the web 32 is moving. The plurality of separate streams of particulate material can also be discharged adjacent to each other, and the (combined) width of the adjacently streams can also be oriented along an axis A2 which can be generally parallel to the lateral axis 49 of the web 32. Moreover, the combined width, i.e., W_{O}, or W_{O}′, of the separate, adjacent streams can also approximate the width of the target area 31 on the moving web 32, and, as explained previously, the target area 31 can correspond to the location of an absorbent core component on the moving web 32. As explained in detail previously, this can facilitate the more even distribution of particulate material across the width of the absorbent core, thus providing the different benefits mentioned hereinabove.

Accordingly, what has been described above includes exemplary embodiments of a particulate delivery apparatus and method for distributing particulate material onto a moving web. It is, of course, not possible to describe every conceivable combination of components or methodologies for purposes of this description, but one of ordinary skill in the art may recognize that further combinations and permutations are possible in light of the overall teaching of this disclosure. Accordingly, the description provided herein is intended to be illustrative only, and should be considered to embrace any and all alterations, modifications, and/or variations that fall within the spirit and scope of the appended claims.

What is claimed is:

1. A particulate delivery manifold for distributing particulate material onto a web moving in a first direction, said particulate delivery manifold comprising:
a. a hopper for receiving a supply of particulate material;
b. a plurality of tubular members each having an inlet end communicating with said hopper, and an outlet end for discharging said particulate material from said hopper onto said moving web; and
c. wherein said plurality of tubular members define a plurality of separate flow paths through which to discharge said particulate material onto said moving web.

2. The particulate delivery manifold of claim 1 further comprising:
a. said plurality of tubular members being connected at said inlet ends to said hopper with each of said inlet ends disposed adjacent each other and parallel to a first axis;
b. said plurality of tubular members extending downwardly from said hopper and being configured such that each of said outlet ends are disposed adjacent each other and parallel to a second axis; and
c. wherein said second axis is substantially perpendicular to said first axis.

3. The particulate delivery manifold of claim 2 wherein said downwardly extending tubular members are positioned at an angle with respect to said moving web such that said particulate material is discharged downwardly toward said moving web and generally in said first direction.

4. The particulate delivery manifold of claim 3 further comprising a mesh grate disposed in said hopper adjacent to and covering said inlet openings.

5. The particulate delivery manifold of claim 2 further comprising:
a. a target area on said moving web, said target area having a predetermined width;
b. said second axis generally parallel a lateral axis of said moving web, and said target area having a predetermined width along said lateral axis; and
c. said adjacent outlet openings having a combined width oriented along said second axis; and
d. wherein said combined width of said outlet openings approximates said predetermined width of said target area such that an even distribution of said particulate material across said width of said target area is facilitated.

6. A particulate delivery device for discharging particulate material onto a web moving in a first direction, said particulate delivery device comprising:
a. a hopper for receiving said particulate material;
b. at least one tubular member having an inlet end communicating with said hopper and an outlet end for discharging said particulate material from said hopper onto said moving web; and
c. said outlet end having a height and a width, wherein said width is substantially greater than said height such that said outlet end is in the shape of an elongated slot; and
d. wherein the width of said elongated slot is oriented along a first axis generally corresponding to a lateral axis of said web.

7. The particulate delivery device of claim 6 further comprising:
a. a target area on said web, said target area having a predetermined width; and
b. said width of said outlet end approximating said width of said target area such that an even distribution of said particulate material across the width of said target area is facilitated.

8. The particulate delivery device of claim 6 further comprising said at least one downwardly extending tubular member positioned at an angle with respect to said moving web such that said particulate material is discharged downwardly toward said moving web and generally in said first direction.

9. The particulate delivery device of claim 8 further comprising:
a. said inlet end having said elongated slot shape with a width substantially greater than a height thereof, and the width of said inlet end is oriented along a second axis; and
b. wherein said second axis generally is generally perpendicular to said first axis.

10. The particulate delivery device of claim 6 wherein said at least one tubular member has a cross section in the shape of an elongated slot with a width greater than a height thereof.

11. The particulate delivery device of claim 6 further comprising at least one partition positioned within said at least one tubular member, said at least one partition terminating near said outlet end, and said partition defining a plurality of separate flow paths near said outlet end.

12. A method for distributing particulate material onto a web moving in a first direction, said method comprising discharging said particulate material onto a target area on said moving web as a plurality of separate streams of said particulate material.

13. The method of claim 12 wherein said plurality of separate streams of particulate material are discharged adjacent each other and oriented along a first axis generally corresponding to a lateral axis of said moving web.

14. The method of claim 13 further comprising distributing said particulate material onto a target area on said moving web, and wherein said plurality of adjacently discharged streams or particulate material define a width along said first axis, and said width generally corresponds to a width of said target area such that an even distribution of said particulate material across a width of said target area is facilitated.

15. The method of claim 14 wherein said target area corresponds to the location of an absorbent core on said moving web such that said particulate material is evenly distributed across said absorbent core.

16. The method of claim 12 further comprising said plurality of separate streams of particulate material being discharged onto said moving web generally in a direction corresponding to said first direction.
